(19) United States
(12) Patent Application Publication
(10) Pub. No.: US 2022/0147980 A1
(43) Pub. Date: May 12, 2022

(54) SERVER, INFORMATION PROCESSING DEVICE, SETTLEMENT SYSTEM, AND METHOD

(71) Applicant: TOSHIBA TEC KABUSHIKI KAISHA, Tokyo (JP)

(72) Inventor: Masamichi YAMAMOTO, Shizuoka Shizuoka (JP)

(73) Assignee: TOSHIBA TEC KABUSHIKI KAISHA, Tokyo (JP)

(21) Appl. No.: 17/580,424

(22) Filed: Jan. 20, 2022

Related U.S. Application Data
(62) Division of application No. 17/185,947, filed on Feb. 25, 2021.

(30) Foreign Application Priority Data
Apr. 1, 2020 (JP) 2020-065839

(51) Int. Cl. G06Q 20/38; G06Q 20/20; G06Q 20/32

(52) U.S. Cl. CPC G06Q 20/387; G06Q 20/3274; G06Q 20/20

(57) ABSTRACT

A server includes a communication interface, a memory, and a processing circuit. The memory is configured to store a plurality of user IDs and necessity information associated with each of the plurality of user IDs. Each of the plurality of user IDs is associated with a respective customer. The necessity information indicates whether the respective customer has chosen to require that use of benefits during transactions be confirmed by the respective customer before the benefits are applied to the transactions. The processing circuit is configured to receive a respective user ID and a request for code information from an information processing device via the communication interface, acquire the necessity information associated with the respective user ID from the memory, issue the code information in response to receiving the request for the code information, and transmit the code information and the necessity information to the information processing device via the communication interface.

### CROSS-REFERENCE TO RELATED APPLICATIONS

This application is a divisional of U.S. patent application Ser. No. 17/185,947, filed Feb. 25, 2021, which is based upon and claims the benefit of priority from Japanese Patent Application No. 2020-065839, filed Apr. 1, 2020, the entire contents of which are incorporated herein by reference.

### FIELD

Embodiments described herein relate generally to a server, an information processing device, a settlement system, and a method.

### BACKGROUND

Currently, cashless settlement is widely used, and a service called two-dimensional code settlement is widely used. In the two-dimensional code settlement, for example, a two-dimensional code such as a QR code (registered trade name) displayed on a screen of a mobile terminal of a customer is read by a scanner provided in a store for settlement, and a checkout process can be rapidly executed. In the two-dimensional code settlement, in order to reduce the risk of information-stealing when a two-dimensional code is used multiple times, a one-time code whose expiration is determined is used. The one-time code is a type of code information represented by the two-dimensional code displayed on the mobile terminal.

On the other hand, as part of customer services, for example, a store may issue a coupon online to provide a benefit to a customer. The customer can receive the benefit, for example, by displaying a barcode or the like representing the information of the coupon issued online on the mobile terminal during checkout and causing a scanner provided in the store to read the barcode.

In the related art, in order to facilitate a process in a store, a technique of using a two-dimensional code representing code information such as a one-time code to execute the use of a coupon and two-dimensional code settlement at the same time is suggested (for example, Japanese Patent No. 6473539).

However, when a mechanism in which a customer always uses a usable benefit is adopted, there is a concern that the customer uses a benefit that the customer does not want to use. For example, in the case of a one-time discount coupon or the like, the customer may not want to use the coupon when the purchase amount is small. In addition, if a clerk asks the customer whether or not to use a benefit for every checkout, a long period of time is required for checkout, and thus the significance of using two-dimensional code settlement for rapidly executing a checkout process may fade.

### DESCRIPTION OF THE DRAWINGS

FIG. 1 is a diagram illustrating a settlement system according to a first embodiment;

FIG. 2 is a block diagram illustrating a hardware configuration of a mobile terminal according to the first embodiment;

FIG. 3 is a block diagram illustrating a functional configuration of the mobile terminal according to the first embodiment;

FIG. 4 is a block diagram illustrating a hardware configuration of a POS terminal according to the first embodiment;

FIG. 5 is a diagram illustrating a data configuration of a benefit information unit according to the first embodiment;

FIG. 6 is a block diagram illustrating a functional configuration of the POS terminal according to the first embodiment;

FIG. 7 is a block diagram illustrating a hardware configuration of a server according to the first embodiment;

FIG. 8 is a data configuration illustrating a necessity information unit according to the first embodiment;

FIG. 9 is a diagram illustrating a data configuration of a one-time code information unit according to the first embodiment;

FIG. 10 is a block diagram illustrating a functional configuration of the server according to the first embodiment;

FIG. 11 is a sequence chart illustrating the flow of processes of the settlement system according to the first embodiment;

FIG. 12 is a flowchart illustrating a checkout process by a control unit in the server according to the first embodiment;

FIG. 13 is a flowchart illustrating a benefit process by a control unit in the POS terminal according to the first embodiment; and

FIG. 14 is a sequence chart illustrating the flow of processes of a settlement system according to a second embodiment.

### DETAILED DESCRIPTION

Embodiments provide a server, an information processing device, a settlement system, and a method in which checkout can be smoothly executed according to a request of a customer relating to the use of a benefit during settlement utilizing a two-dimensional code or the like.

In general, according to one embodiment, the server includes a reception unit that receives a user ID used for settlement using a code symbol, and a request for code information represented by the code symbol from an information processing device, an extraction unit that extracts necessity information of the user ID received by the reception unit from a storage unit that stores the user ID and the necessity information indicating whether or not it is necessary to check the use of a benefit that is usable during checkout in correlation with each other, and an output unit that outputs the code information and the necessity information extracted by the extraction unit.

### First Embodiment

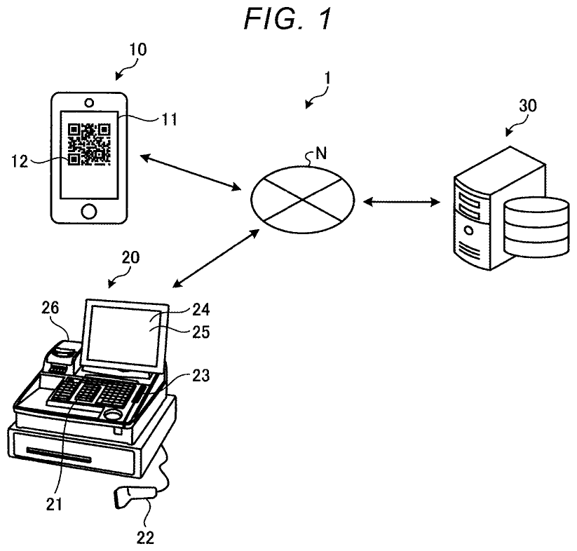

Hereinafter, a settlement system according to a first embodiment will be described with reference to the drawings. FIG. 1 is a diagram illustrating the settlement system. A settlement system 1 includes a mobile terminal 10, a point of sales (POS) terminal 20, and a server 30. The mobile terminal 10 and the POS terminal 20 are connected to the server 30 via a network N. The network N is a dedicated line such as a virtual private network (VPN) or a public Internet line.

The mobile terminal 10 is an example of an information processing device. The mobile terminal 10 is, for example, a smartphone owned by a customer (hereinafter, also referred to as “user”) or a tablet PC that is lent to a customer in a store where the POS terminal 20 is provided. The mobile terminal 10 includes a display or display unit 11. The display unit 11 is configured with, for example, a liquid crystal panel and displays various information. A touch panel 12 is provided on a surface of the display unit 11. The touch panel 12 inputs information corresponding to a touched position to the control unit of the mobile terminal 10 and functions as an operation input unit that inputs an operation of the user.

The POS terminal 20 is an example of a settlement terminal. The settlement terminal may be a self-service-type POS terminal or a semi-self-service-type checkout device. The POS terminal 20 is installed in, for example, a checkout counter of a supermarket or the like. The POS terminal 20 includes, for example, a keyboard 21, a scanner 22, a card reader 23, a display or display unit 24, a touch panel 25, and a printer 26.

The keyboard 21 includes, for example, numeric keys for inputting a commodity code specifying a commodity, a price, and the like, a subtotal key for declaring the calculation of a sales total amount, and a cash total key for declaring settlement by cash in sales processing.

The scanner 22 optically recognizes a barcode attached to a commodity or a two-dimensional code displayed on the mobile terminal 10. The card reader 23 reads a user ID for identifying a customer from a membership card distributed to the customer in advance. In addition, when the customer executes credit card settlement, the card reader 23 reads the content of a card.

The display unit 24 is configured with, for example, a liquid crystal panel and displays various information. The touch panel 25 is provided on a surface of the display unit 24. The touch panel 25 inputs information corresponding to a touched position to the control unit of the POS terminal 20. The printer 26 prints and dispenses a receipt.

The server 30 is managed by, for example, an operating company of two-dimensional code settlement, or a service company that provides a service related to two-dimensional code settlement between a store and an operating company of two-dimensional code settlement. For example, the service company makes a contract with a plurality of operating companies of two-dimensional code settlement and provides various kinds of two-dimensional code settlement services to a store.

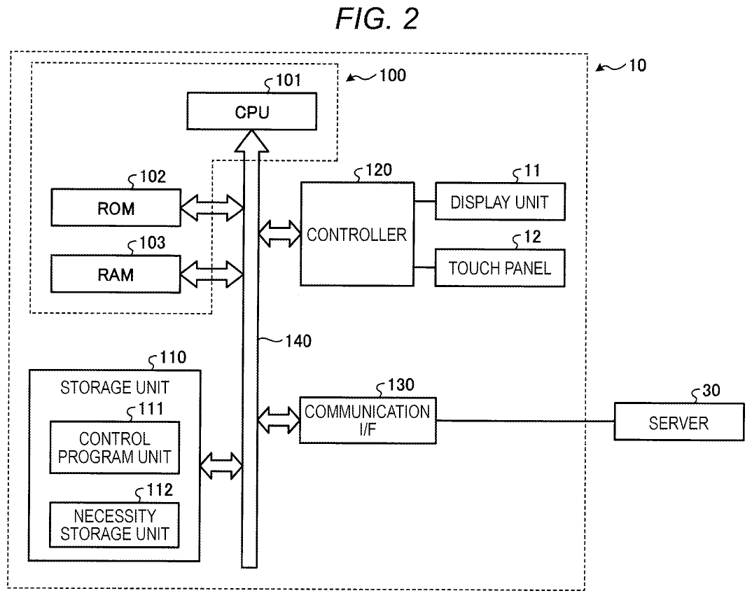

Next, a hardware configuration of the mobile terminal 10 will be described with reference to FIG. 2. FIG. 2 is a block diagram illustrating a hardware configuration of the mobile terminal 10. The mobile terminal 10 includes, for example, a control unit 100 (a processing circuit), a storage unit 110 (a memory or memory device), a controller 120, and a communication interface (I/F) 130. The control unit 100, the storage unit 110, the controller 120, and the communication I/F 130 are connected to each other via a bus 140.

The control unit 100 includes a Central Processing Unit (CPU) 101, a Read Only Memory (ROM) 102, and a Random Access Memory (RAM) 103. The CPU 101, the ROM 102, and the RAM 103 are connected to each other via the bus 140. The CPU 101 controls the entire mobile terminal 10. The ROM 102 stores various programs such as a program used for driving the CPU 101, and various data. The RAM 103 is used as a work area of the CPU 101 and loads various programs or various data stored in the ROM 102 or the storage unit 110. The control unit 100 executes various control processes of the mobile terminal 10 by the CPU 101 operating in accordance with a control program stored in the ROM 102 and the storage unit 110 and loaded to the RAM 103.

The storage unit 110 includes a control program unit 111 and a necessity storage unit 112. The control program unit 111 stores various control programs. The necessity storage unit 112 stores necessity information representing the necessity of a check (hereinafter, also referred to as “necessity check”) related to the use of a benefit that is usable during checkout, that is, necessity information representing whether or not an operator needs to ask a user whether or not to use an available benefit during checkout. The necessity information is input from the touch panel 12 by the customer.

The controller 120 is connected to the display unit 11 and the touch panel 12. As a result, the control unit 100 can transmit and receive data to and from the display unit 11 and the touch panel 12 through the controller 120. The communication I/F 130 is connected to the server 30 via the network N. As a result, the control unit 100 can transmit and receive data to and from the server 30.

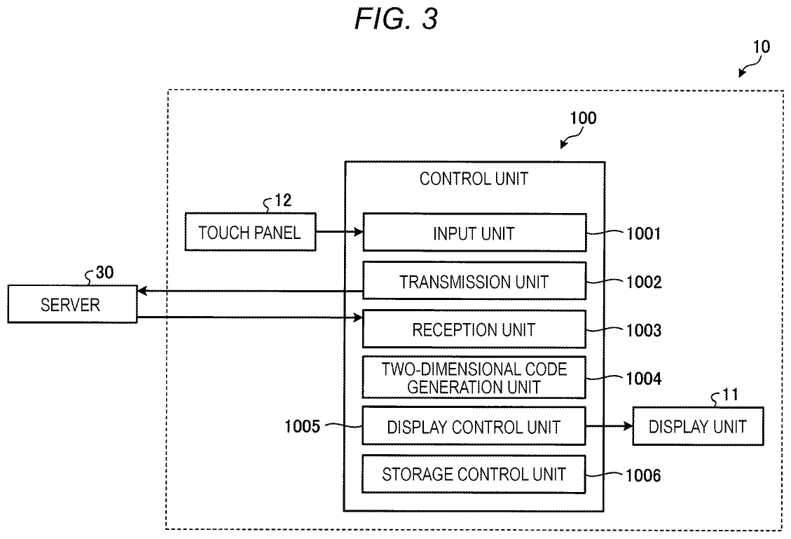

Next, a functional configuration of the control unit 100 of the mobile terminal 10 will be described with reference to FIG. 3. FIG. 3 is a block diagram illustrating a functional configuration of the mobile terminal 10. By the CPU 101 operating in accordance with the control program stored in the ROM 102 or the storage unit 110, the control unit 100 functions as an input unit 1001, a transmission unit 1002, a reception unit 1003, a two-dimensional code generation unit 1004, a display control unit 1005, and a storage control unit 1006. The respective functional configurations may be implemented by hardware and the mobile terminal 10 only needs to have the above-described functions.

The input unit 1001 receives information input to the touch panel 12 by the user. For example, when the user executes two-dimensional code settlement for shopping, the input unit 1001 receives an input of an instruction to start an application program of two-dimensional code settlement stored in the control program unit 111.

The transmission unit 1002 transmits a user ID used for settlement using a code symbol and a request for code information represented by the code symbol to the server 30. Specifically, the transmission unit 1002 transmits a user ID specifying the user of the mobile terminal 10 and a request for code information represented by a two-dimensional code (an example of the code symbol) displayed by the display unit 11 for executing two-dimensional code settlement, to the server 30. The code information includes a one-time code that is issued by the server 30 and whose expiration is set.

The reception unit 1003 receives the code information and necessity information indicating whether or not it is necessary to check the use of a benefit that is usable during checkout from the server 30. Specifically, the reception unit 1003 receives the one-time code, the necessity information, and the like from the server 30 in response to the request for code information transmitted by the transmission unit 1002.

The two-dimensional code generation unit 1004 generates a two-dimensional code displayed by the display unit 11 based on the information and the like received by the reception unit 1003. The two-dimensional code generation unit 1004 generates a two-dimensional code representing the one-time code, the necessity information, the user ID, and the like received from the server 30 by the reception unit 1003. The necessity information may be read from the necessity storage unit 112. In addition, the user ID may be stored in the storage unit 110 and may be read from the storage unit 110 when the two-dimensional code is generated. The two-dimensional code generation unit 1004 may be provided in the server 30. In this case, the reception unit 1003 receives the code information and the necessity information, as the two-dimensional code, from the server 30.

The display control unit 1005 causes the display unit 11 to display the code information, the necessity information, and the code symbol representing the user ID, which were received by the reception unit 1003. Specifically, the display control unit 1005 causes the display unit 11 to display the two-dimensional code generated by the two-dimensional code generation unit 1004.

The storage control unit 1006 stores necessity information representing the necessity to check the use of a benefit that is usable during checkout, in the storage unit 110. Specifically, the storage control unit 1006 stores the necessity information input from the touch panel 12 in the necessity storage unit 112. When the server 30 stores the user ID and the necessity information in correlation with each other as in the embodiment, the necessity storage unit 112 is not necessarily provided in the mobile terminal 10. The necessity storage unit 112 is used in a second embodiment described below.

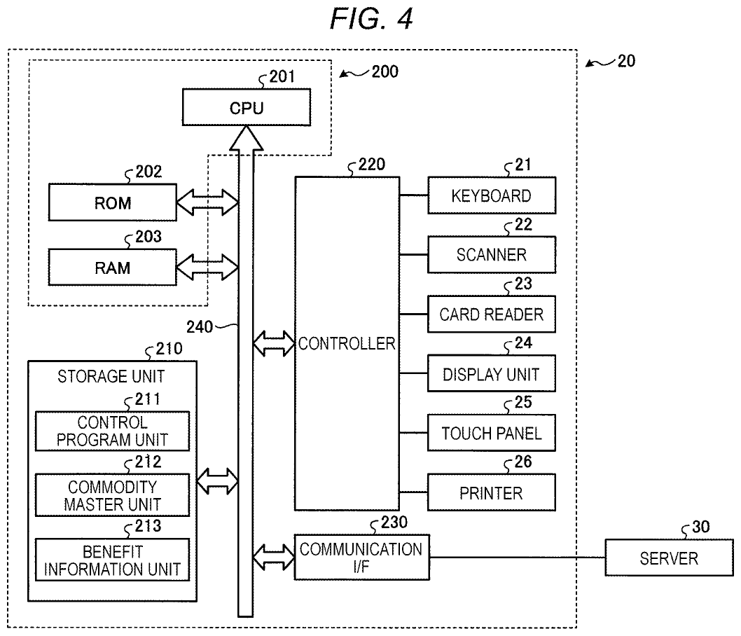

Next, a hardware configuration of the POS terminal 20 will be described with reference to FIG. 4. FIG. 4 is a block diagram illustrating a hardware configuration of the POS terminal 20. The POS terminal 20 includes, for example, a control unit 200 (a processing circuit), a storage unit 210 (a memory or memory device), a controller 220, and a communication OF 230. The control unit 200, the storage unit 210, the controller 220, and the communication I/F 230 are connected to each other via a bus 240.

The control unit 200 includes a CPU 201, a ROM 202, and a RAM 203. The CPU 201, the ROM 202, and the RAM 203 are connected to each other via the bus 240. The CPU 201 controls the entire POS terminal 20. The ROM 202 stores various programs such as a program used for driving the CPU 201, and various data. The RAM 203 is used as a work area of the CPU 201 and loads various programs or various data stored in the ROM 202 or the storage unit 210. The control unit 200 executes various control processes of the POS terminal 20 by the CPU 201 operating in accordance with a control program stored in the ROM 202 or the storage unit 210 and loaded to the RAM 203.

The storage unit 210 is configured with a hard disk drive (HDD) or the like. The storage unit 210 includes a control program unit 211, a commodity master unit 212, and a benefit information unit 213. The control program unit 211 stores various control programs. The commodity master unit 212 stores a commodity master representing commodity information. In the commodity master, the commodity information includes a commodity name, a price, and the like that are correlated to a commodity code that can identify the type of the commodity. Since the commodities handled at the store change every day, the commodity master is appropriately updated based on information from a store server (not illustrated).

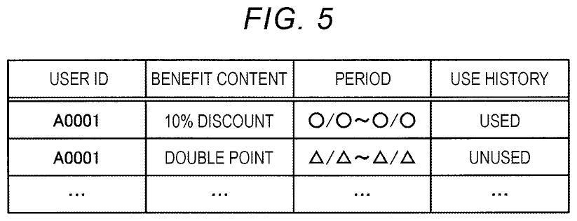

The benefit information unit 213 stores a benefit information file. FIG. 5 illustrates a data configuration of the benefit information file. The benefit information file stores benefit information for each member. The benefit information includes a user ID that specifies a member, a benefit content that can be used by the member specified by the user ID, a period in which the benefit can be used, and a use history of the benefit, in correlation with each other. A user ID may be set separately from IDs that specify members such that a user other than the members can use the settlement system 1. The benefit information file is appropriately updated. For example, if a benefit such as being able to use a one-time discount coupon after the next shopping occurs under the condition that the user purchases commodities corresponding to a certain amount within a predetermined period of time, the benefit is added to the benefit information file when the condition is satisfied. In addition, when a use period of the registered benefit is passed, the benefit is removed from the benefit information file. The benefit information file may be stored in the store server. In this case, the POS terminal 20 accesses the store server and refers to the benefit information file for every checkout process.

Referring back to FIG. 4, the controller 220 is connected to the keyboard 21, the scanner 22, the card reader 23, the display unit 24, the touch panel 25, and the printer 26. As a result, the control unit 200 can transmit and receive data to and from the keyboard 21, the scanner 22, the card reader 23, the display unit 24, the touch panel 25, and the printer 26 through the controller 120. The communication I/F 230 is connected to the server 30. As a result, the control unit 200 can transmit and receive data to and from the server 30.

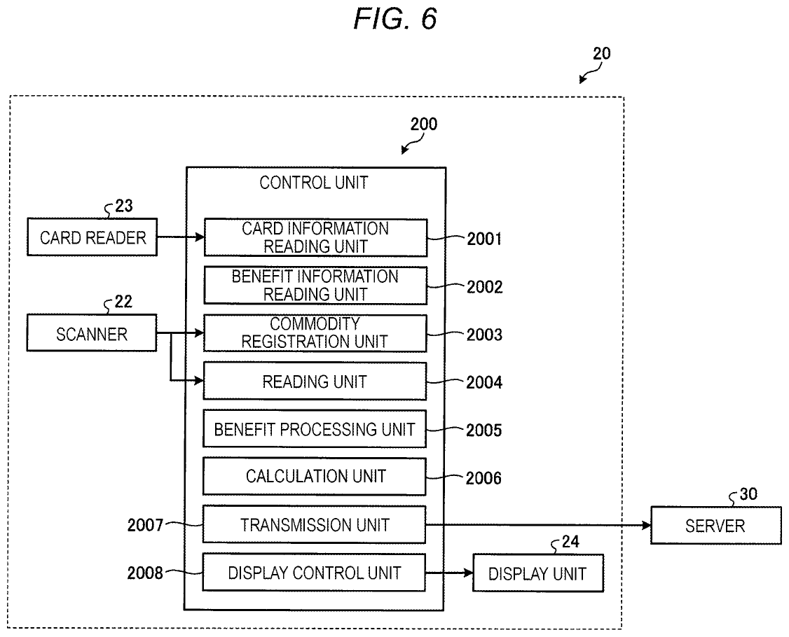

Next, a functional configuration of the control unit 200 of the POS terminal 20 will be described with reference to FIG. 6. FIG. 6 is a functional block diagram illustrating the functional configuration of the POS terminal 20. By the CPU 201 operating in accordance with the control program stored in the ROM 202 or the storage unit 210, the control unit 200 functions as a card information reading unit 2001, a benefit information reading unit 2002, a commodity registration unit 2003, a reading unit 2004, a benefit processing unit 2005, a calculation unit 2006, a transmission unit 2007, and a display control unit 2008. The respective functional configurations may be implemented by hardware and the POS terminal 20 only needs to have the above-described functions.

The card information reading unit 2001 reads the user ID based on the information read from a membership card by the card reader 23. The card information reading unit 2001 can read the user ID until the subtotal key for declaring the calculation of a sales total amount is input.

When the card information reading unit 2001 reads the user ID, the benefit information reading unit 2002 reads the benefit information of the user specified by the user ID. More specifically, with the user ID read by the card information reading unit 2001 as a key, the benefit information reading unit 2002 searches the benefit information file and reads usable benefit information.

The commodity registration unit 2003 registers a commodity based on barcode information and the like read by the scanner 22. The commodity registration means that the commodity information acquired from the commodity master based on a commodity code recognized from the barcode information and a commodity code input from the keyboard 21 is temporarily stored in the RAM 203 or the like until the settlement is completed.

The reading unit 2004 reads information represented by the code symbol. Specifically, the reading unit 2004 reads information represented by the two-dimensional code displayed by the display unit 11 of the mobile terminal 10 based on the information read by the scanner 22. More specifically, the reading unit 2004 reads the code information such as the one-time code represented by the two-dimensional code, the necessity information, and the user ID.

The benefit processing unit 2005 executes a process related to a benefit of the user specified by the user ID based on the user ID and the necessity information read by the reading unit 2004. Specifically, when the necessity information represents “unnecessary”, that is, represents that the necessity check is unnecessary, the benefit processing unit 2005 instructs the calculation unit 2006 to execute a process of using the benefit that can be used by the user, for example, to calculate a total amount discounted based on the benefit. When the necessity information represents “necessary”, that is, represents that the necessity check is necessary, the benefit processing unit 2005 instructs the display unit 24 to display the benefit contents that can be used by the user. When the necessity information is “unnecessary”, the benefit processing unit 2005 may instruct the calculation unit 2006 to execute a process of not using the benefit that can be used by the user, for example, to calculate a normal total amount based on the commodity registration. That is, when the necessity information is “unnecessary”, the benefit processing unit 2005 may set the benefit to be automatically used or may set the benefit not to be automatically used. It is also possible to allow the user to select whether or not to set the benefit to be automatically used. For example, when the user registers the necessity information using the mobile terminal 10, the user may select whether or not to set the benefit to be automatically used. In this case, if the code information represented by the two-dimensional code includes information representing the setting selected by the user, the POS terminal 20 can recognize the setting selected by the user. The benefit is not limited to discounts, various benefits such as price reduction of a certain amount or an increase in point accumulation rate.

The calculation unit 2006 calculates a total amount related to one transaction. The calculation unit 2006 calculates a total amount based on the instruction from the benefit processing unit 2005, generates settlement information based on the calculated total amount or the like, and causes the display unit 24 to display the generated settlement information. The settlement information includes information regarding a purchased commodity such as a commodity name and a unit price, and a total amount.

The transmission unit 2007 transmits the user ID and the settlement information to the server 30. Specifically, the transmission unit 2007 transmits the user ID read by the reading unit 2004 and the settlement information generated by the calculation unit 2006 to the server 30.

The display control unit 2008 causes the display unit 24 to display various information. For example, the display control unit 2008 causes the display unit 24 to display, for example, the information regarding a commodity registered by the commodity registration unit 2003, the information regarding the discount process executed by the benefit processing unit 2005, and the settlement information generated by the calculation unit 2006.

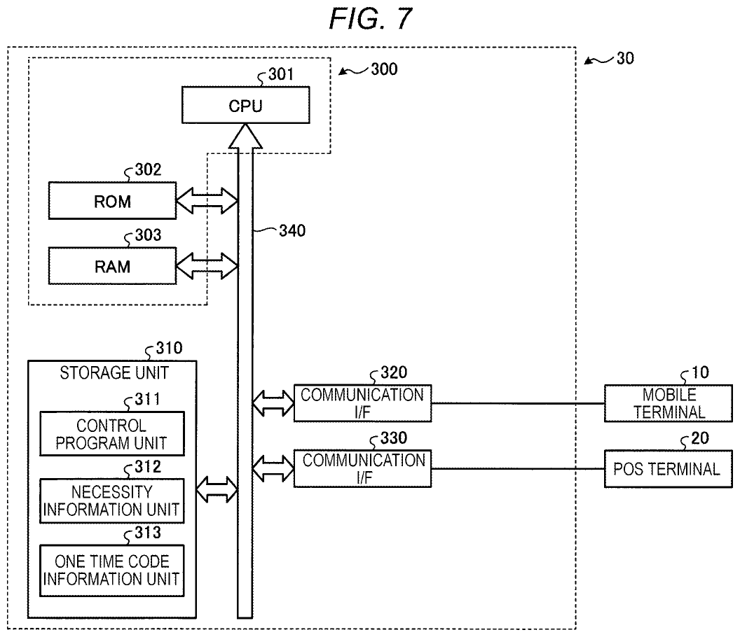

Next, a hardware configuration of the server 30 will be described with reference to FIG. 7. FIG. 7 is a block diagram illustrating the hardware configuration of the server 30. The server 30 includes, for example, a control unit 300 (a processing circuit), a storage unit 310 (a memory or memory device), communication I/F 320, and communication I/F 330. The control unit 300, the storage unit 310, the communication I/F 320, and the communication I/F 330 are connected to each other via a bus 340.

The control unit 300 includes a CPU 301, a ROM 302, and a RAM 303. The CPU 301, the ROM 302, and the RAM 303 are connected to each other via the bus 340. The CPU 301 controls the entire server 30. The ROM 302 stores various programs such as a program used for driving the CPU 301, and various data. The RAM 303 is used as a work area of the CPU 301 and loads various programs or various data stored in the ROM 302 or the storage unit 310. The control unit 300 executes various control processes of the server 30 by the CPU 301 operating in accordance with a control program stored in the ROM 302 or the storage unit 310 and loaded to the RAM 303.

The storage unit 310 is configured with, for example, a HDD. The storage unit 310 includes a control program unit 311, a necessity information unit 312, and a one-time code information unit 313. The control program unit 311 stores various control programs.

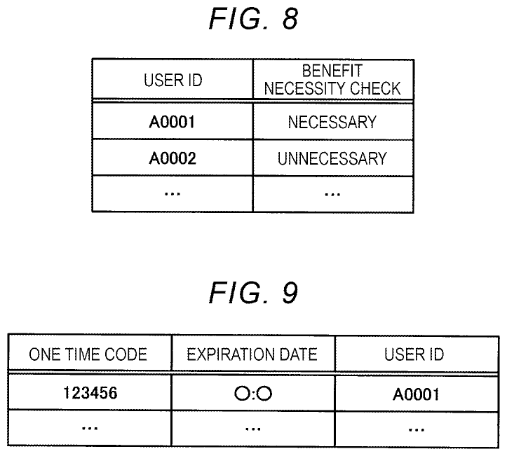

The necessity information unit 312 stores a necessity information file. FIG. 8 is a diagram illustrating a data configuration of the necessity information file. The necessity information file stores the user ID and a benefit necessity check as the necessity information in correlation with each other. The user whose benefit necessity check is “necessary” is a user who needs to check whether or not to use a benefit during checkout. This check may be executed orally by an operator or may be executed by causing the display unit 24 of the POS terminal 20 to display a selection button for selecting whether or not to use a benefit and allowing the user to select whether or not to use the benefit. The user whose benefit necessity check is “unnecessary” is a user who does not need to check whether or not to use a benefit during checkout. The benefit necessity check can be appropriately changed by an input of the user to the mobile terminal 10.

The one-time code information unit 313 stores a one-time code information file. FIG. 9 is a diagram illustrating a data configuration of the one-time code information file. The one-time code information file is a file for managing a one-time code issued by an issuing unit described below. The one-time code information file stores the issued one-time code, the expiration of the one-time code, the user ID of a user to whom the one-time code is issued, in correlation with each other.

Referring back to FIG. 7, the communication I/F 320 is connected to the mobile terminal 10. The communication I/F 330 is connected to the POS terminal 20. As a result, the control unit 300 can transmit and receive data to and from the mobile terminal 10 and the POS terminal 20.

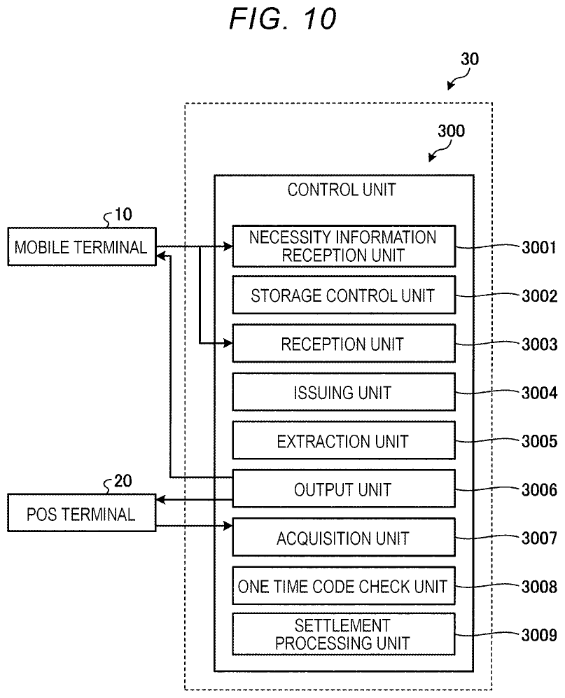

Next, a functional configuration of the control unit 300 of the server 30 will be described with reference to FIG. 10. FIG. 10 is a block diagram illustrating the functional configuration of the server 30. By the CPU 301 operating in accordance with the control program stored in the ROM 302 or the storage unit 310, the control unit 300 functions as a necessity information reception unit 3001, a storage control unit 3002, a reception unit 3003, an issuing unit 3004, an extraction unit 3005, an output unit 3006, an acquisition unit 3007, a one-time code check unit 3008, and a settlement processing unit 3009. The respective functional configurations may be implemented by hardware and the server 30 only needs to have the above-described functions. In addition, the server 30 may be configured with a plurality of computers.

The necessity information reception unit 3001 receives the user ID and the necessity information from the mobile terminal 10. The necessity information is information indicating whether or not it is necessary to check whether or not the user uses the benefit during the checkout of shopping of the user.

The storage control unit 3002 stores the content received by the necessity information reception unit 3001 in the necessity information unit 312 and updates the necessity information file. In addition, the storage control unit 3002 appropriately updates the one-time code information file stored in the one-time code information unit 313. For example, if the issuing unit 3004 issues a one-time code, the storage control unit 3002 stores the issued one-time code, the expiration, and the user ID in the one-time code information file. In addition, the storage control unit 3002 deletes the one-time code whose expiration was passed, the one-time code used for completed settlement, and the like from the one-time code information file.

The reception unit 3003 receives the user ID and a request for code information from the mobile terminal 10. Specifically, the reception unit 3003 receives the user ID and a request for code information represented by the two-dimensional code for executing two-dimensional code settlement. The code information includes the one-time code.

When the reception unit 3003 receives the request for code information, the issuing unit 3004 issues a one-time code. The issuing unit 3004 sets the expiration of the one-time code.

The extraction unit 3005 extracts the necessity information of the user ID received by the reception unit 3003 from the storage unit 310 that stores the user ID and the necessity information indicating whether or not it is necessary to check the use of a benefit that is usable during checkout in correlation with each other. Specifically, with the user ID received by the reception unit 3003 as a key, the extraction unit 3005 searches the necessity information file and extracts necessity information corresponding to the user ID.

The output unit 3006 outputs the code information and the necessity information extracted by the extraction unit 3005. Specifically, the output unit 3006 transmits not only the one-time code issued by the issuing unit 3004 but also the necessity information extracted by the extraction unit 3005 to the mobile terminal 10 of the user specified by the user ID received by the reception unit 3003. The output unit 3006 may generate a two-dimensional code including the user ID, the one-time code, and the necessity information and may transmit the two-dimensional code to the mobile terminal 10.

The acquisition unit 3007 acquires the user ID and the settlement information from the settlement terminal. Specifically, the acquisition unit 3007 receives the user ID and the settlement information of the user specified by the user ID from the POS terminal 20. The settlement information includes, for example, information regarding the commodity purchased by the user, and a total amount. Further, the acquisition unit 3007 also receives the one-time code correlated with the user ID from the POS terminal 20.

The one-time code check unit 3008 checks whether or not the one-time code acquired by the acquisition unit 3007 is stored in the one-time code information file. That is, the one-time code check unit 3008 checks whether or not the one-time code acquired by the acquisition unit 3007 is deleted from the one-time code information file without passing the expiration. In addition, the one-time code check unit 3008 checks whether or not the user ID and the one-time code acquired by the acquisition unit 3007 are stored in the one-time code information file in correlation with each other. That is, the one-time code check unit 3008 checks whether or not the one-time code issued by the issuing unit 3004 is used by the user in response to the request from the user, in other words, whether or not a settlement is requested by an appropriate user.

The settlement processing unit 3009 executes a settlement process based on the user ID and the settlement information acquired by the acquisition unit 3007. Specifically, when the one-time code check unit 3008 confirms that settlement is requested by an appropriate user, the settlement processing unit 3009 executes a process related to the settlement of the user. The settlement process is a process performed by the server 30 for the user to execute the settlement of transactions. When the server 30 is managed by an operating company of the two-dimensional code settlement, the settlement process includes, for example, a process of withdrawing money from an account of the user. In addition, when the server 30 is managed by a company that provides a service related to two-dimensional code settlement between the store and the operating company of the two-dimensional code, the settlement process includes, for example, notification for instructing the operating company of two-dimensional code settlement to execute settlement.

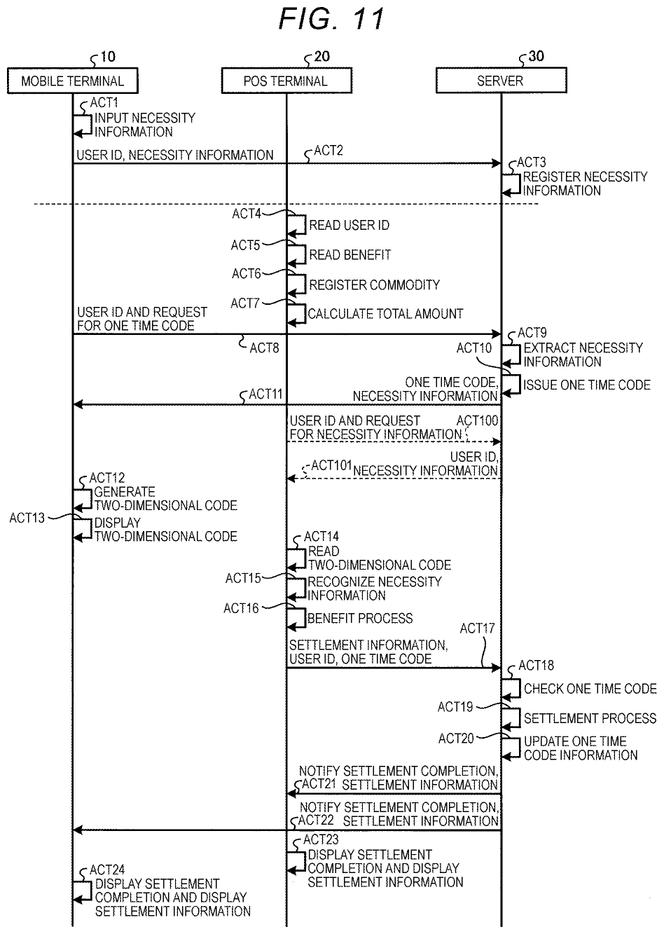

The operation of the settlement system 1 based on the above-described configuration will be described with reference to FIG. 11. FIG. 11 is a sequence chart illustrating the flow of processes of the settlement system 1. FIG. 11 illustrates the flow of the processes when settlement is completed without an error occurrence.

First, a process of the user registering the necessity information will be described. When the user uses the service according to the embodiment, the user registers the necessity information in advance before shopping. For example, the user starts application software of two-dimensional code settlement installed in the mobile terminal 10 and inputs the necessity information to the mobile terminal 10. The input unit 1001 of the mobile terminal 10 receives the input of the necessity information (ACT 1). The transmission unit 1002 transmits the user ID and the input necessity information to the server 30 (ACT 2). When the necessity information reception unit 3001 receives the user ID and the necessity information, the server 30 registers (stores) the necessity information in the necessity information unit 312 and updates the necessity information file (ACT 3). When the necessity information is registered as “unnecessary”, the user can select the benefit process that is automatically executed. That is, the user can select whether to set the benefit to be automatically used or not to be automatically used at the time of checkout. As a result, the necessity information of the user is stored in the server 30. The benefit of the user is processed based on the registered necessity information for every checkout. When the user changes the necessity information registered in the necessity information unit 312, the processes ACT 1 to ACT 3 are executed.

Next, processes during checkout when the user executes payment will be described. “During checkout” refers to a period of time from the start of registration of a commodity to be purchased by the user to the completion of the settlement process. During the checkout, the card information reading unit 2001 in the POS terminal 20 reads the user ID (ACT 4). The user ID is read by the operator reading the membership card of the user with the card reader 23. Next, the benefit information reading unit 2002 reads a valid benefit stored in the benefit information file in correlation with the user ID read by the card information reading unit 2001 from the benefit information file (ACT 5) and stores the valid benefit in the RAM 203. In the embodiment, when there are a plurality of valid benefits stored in correlation with the user ID, the benefit information reading unit 2002 reads a benefit whose end of the use period is the earliest. However, in the above-described case, the benefit information reading unit 2002 may read all the benefits or may read one benefit under a different condition.

Next, the operator reads a barcode of a commodity with the scanner 22, and the commodity registration unit 2003 registers the commodity (ACT 6). For a commodity to which a barcode is not attached, the operator inputs the commodity code with the keyboard 21 to register the commodity. When the registration of all the commodities to be purchased by the user is completed, the control unit 200 calculates the total amount (ACT 7).

The user who desires two-dimensional code settlement instructs the mobile terminal 10 to transmit a request for a one-time code. The request for a one-time code is an example of the request for code information represented by the code symbol. The transmission unit 1002 in the mobile terminal 10 transmits the user ID and the request for a one-time code to the server 30 (ACT 8). When the reception unit 3003 receives the user ID and the request for a one-time code, the extraction unit 3005 in the server 30 extracts the necessity information store in correlation with the user ID from the necessity information file (ACT 9). Next, in the server 30, the issuing unit 3004 issues a one-time code (ACT 10), the output unit 3006 transmits the one-time code and the necessity information to the mobile terminal 10 (ACT 11).

In the mobile terminal 10, when the reception unit 1003 receives the one-time code and the necessity information, the two-dimensional code generation unit 1004 generates a two-dimensional code (ACT 12). The two-dimensional code generated by the two-dimensional code generation unit 1004 represents information including the user ID, the one-time code, and the necessity information. In the embodiment, it is also possible not to include information directly indicating the user ID in the two-dimensional code. The reason is that, since the one-time code information unit 313 in the server 30 stores the one-time code and the user ID in correlation with each other, the one-time code can also function as the information indicating the user ID. However, by allowing the two-dimensional code to include information directly indicating the user ID, the server 30 can check not only whether or not the one-time code is within the expiration but also whether or not the one-time code and the user ID are correlated with each other. Therefore, whether or not the settlement is requested by an appropriate user can be checked, and the security is improved. Next, the display control unit 1005 in the mobile terminal 10 causes the display unit 11 to display the two-dimensional code generated by the two-dimensional code generation unit 1004 (ACT 13).

In the POS terminal 20, when the scanner 22 reads the two-dimensional code displayed by the mobile terminal 10, the reading unit 2004 reads the information of the two-dimensional code (ACT 14) and recognizes the necessity information in the read information (ACT 15). Next, the benefit processing unit 2005 in the POS terminal 20 executes the benefit process (ACT 16). Although the details will be described below, examples of the benefit process include a process of generating settlement information after executing the discount process based on the benefit read in ACT 5 and stored in the RAM 203. The benefit processing unit 2005 can also be provided in the server 30 such that the server 30 can execute the benefit process. In the POS terminal 20, the transmission unit 2007 transmits the settlement information generated by the benefit processing unit 2005, the user ID, and the one-time code to the server 30 (ACT 17).

In the server 30, when the acquisition unit 3007 acquires the settlement information, the user ID, and the one-time code from the POS terminal 20, the one-time code check unit 3008 checks the one-time code (ACT 18). The one-time code check unit 3008 refers to the one-time code information unit 313 and checks whether or not the one-time code acquired by the acquisition unit 3007 exceeds the expiration. In addition, the one-time code check unit 3008 checks whether or not the one-time code and the user ID acquired by the acquisition unit 3007 are stored in the one-time code information unit 313 in correlation with each other.

As a result of the check by the one-time code check unit 3008, when the one-time code does not exceed the expiration and the one-time code and the user ID acquired are stored in the one-time code information unit 313 in correlation with each other, the settlement processing unit 3009 executes the settlement process (ACT 19). Next, in the server 30, the storage control unit 3002 deletes the one-time code on which the settlement process is processed and updates the one-time code information file (ACT 20).

Next, in the server 30, the output unit 3006 outputs a settlement completion notification and the settlement information whose settlement was processed not only to the POS terminal 20 (ACT 21) but also to the mobile terminal 10 (ACT 22). In the POS terminal 20 that received the settlement notification and the settlement information, the display control unit 2008 causes the display unit 24 to display the settlement notification and the settlement information (ACT 23). Likewise, in the mobile terminal 10 that received the settlement notification and the settlement information, the display control unit 1005 causes the display unit 11 to display the settlement notification and the settlement information (ACT 24).

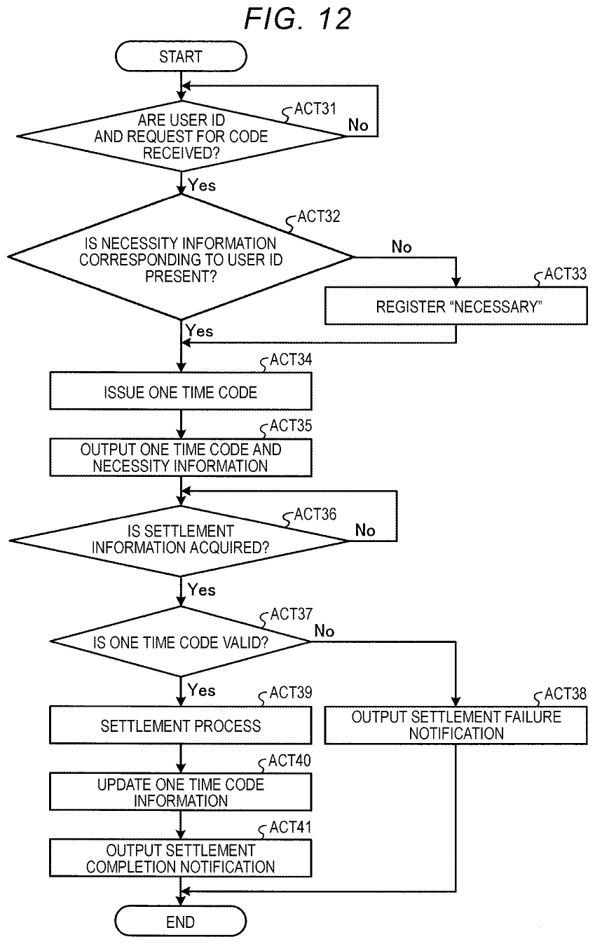

Next, processes related to the settlement of the server 30 in the operation of the above-mentioned settlement system will be described. FIG. 12 is a flowchart illustrating the processes related to the settlement of the server 30. The control unit 300 of the server 30 determines whether or not the reception unit 3003 received the user ID and the request for code information such as a one-time code (ACT 31). When the reception unit 3003 does not receive the user ID and the request for code information (No in ACT 31), the control unit 300 returns to the process of ACT 31 and waits. When the reception unit 3003 received the user ID and the request for code information (Yes in ACT 31), the extraction unit 3005 refers to the necessity information unit 312 and determines whether or not the necessity information is stored in correlation with the received user ID (ACT 32).

When the necessity information is not stored in correlation with the received user ID (No in ACT 32), the storage control unit 3002 updates the necessity information file and registers “necessary” as the necessity information correlated to the user ID (ACT 33), and the control unit 300 proceeds to the process of ACT 34. When the necessity information is not registered by the user, by registering “necessary” in the necessity information, the user can receive the check related to the use of a benefit during checkout. As a result, the benefit process that is not expected by the user can be prevented from being executed. When the necessity information is stored (Yes in ACT 32), that is, the necessity information of the user ID is registered, the issuing unit 3004 issues a one-time code (ACT 34). Next, the output unit 3006 outputs the one-time code and the necessity information stored in the necessity information file to the mobile terminal 10 (ACT 35).

Next, the control unit 300 determines whether or not the acquisition unit 3007 acquired the settlement information, and the user ID from the POS terminal 20 (ACT 36). When the acquisition unit 3007 did not acquire the settlement information and the user ID from the POS terminal 20 (No in ACT 36), the control unit 300 returns to the process of ACT 36 and waits. When the acquisition unit 3007 acquired the settlement information and the user ID from the POS terminal 20 (Yes in ACT 36), the one-time code check unit 3008 refers to the one-time code information unit 313 and determines whether or not the received one-time code is valid (ACT 37). This determination is executed by checking whether or not the one-time code does not exceed the expiration and whether or not the one-time code is stored in the one-time code information unit 313 in correlation with the user ID.

When the one-time code is not valid (No in ACT 37), the output unit 3006 outputs a settlement failure notification to the mobile terminal 10 and the POS terminal 20 (ACT 38) and ends the process. When the one-time code is valid (Yes in ACT 37), the settlement processing unit 3009 executes the settlement process (ACT 39), and the storage control unit 3002 updates the one-time code information file (ACT 40). That is, the storage control unit 3002 deletes the one-time code whose settlement process was completed from the one-time code information file. Next, the output unit 3006 outputs a settlement completion notification to the mobile terminal 10 and the POS terminal 20 (ACT 41) and ends the process.

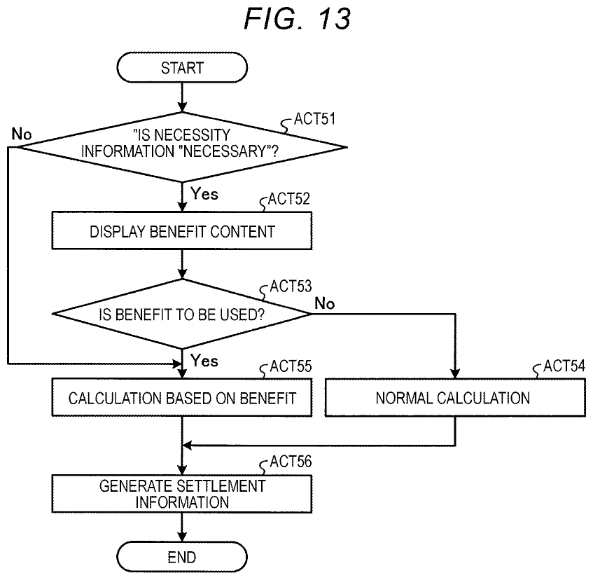

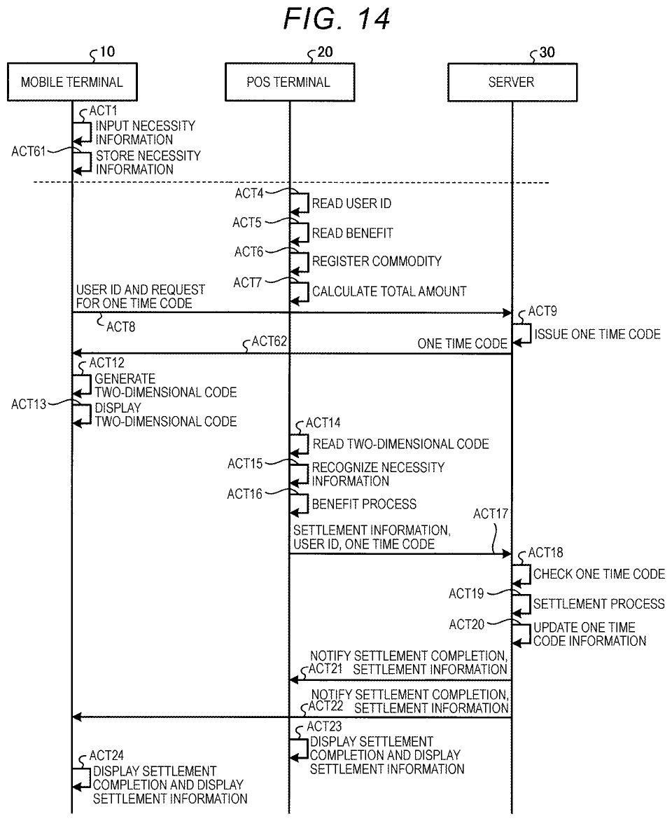

Next, a process of the benefit processing unit of the POS terminal 20 will be described. FIG. 13 is a flowchart illustrating the benefit process by the control unit 200 of the POS terminal 20. The benefit processing unit 2005 determines whether or not the necessity information read by the reading unit 2004 of the POS terminal 20 during checkout is “necessary” (ACT 51).

When the necessity information is not “necessary” (No in ACT 51), the benefit processing unit 2005 proceeds to the process of ACT 55. When the necessity information is “necessary” (Yes in ACT 51), the benefit processing unit 2005 outputs an instruction to the display control unit 2008 to cause the display unit 24 to display the benefit content (ACT 52). Next, the benefit processing unit 2005 determines whether or not the information input by the touch panel 25 is information indicating that the benefit is to be used (ACT 53). When the information input by the touch panel 25 is not information indicating that the benefit is to be used (No in ACT 53), the benefit processing unit 2005 calculates a normal total amount without the benefit (ACT 54) and proceeds to the process of ACT 56. When the information input by the touch panel 25 is information indicating that the benefit is to be used (Yes in ACT 53), the benefit processing unit 2005 calculates a total amount with the benefit applied, for example, a discounted total amount (ACT 55), generates settlement information related to the calculated total mount (ACT 56) and ends the benefit process. The settlement system 1 registers the necessity information and executes the process during checkout according to the above-described flow.

As described above, in the settlement system 1 according to the first embodiment, the server 30 outputs not only the code information but also the necessity information in response to the request for code information from the user. As a result, the information represented by the two-dimensional code that is generated in the mobile terminal 10 or the server 30 and used for settlement can include the necessity information. Therefore, the POS terminal 20 that reads the two-dimensional code during checkout can recognize whether or not the user that executes settlement is a user who needs to check whether or not to use the benefit and can execute the process accordingly. For example, when the user that executes settlement is a user who does not need the necessity check, the POS terminal 20 can automatically execute the process of using the benefit or the process of not using the benefit without checking the request of the user during checkout. Accordingly, the rapid checkout process that is a characteristic of two-dimensional code settlement can be smoothly executed without loss.

The necessity information stored in the server 30 can also be set, for example, by the store but, in the embodiment, is set by an input of the user. Accordingly, the POS terminal 20 can execute a process according to the request of the user during checkout. This way, in the server 30 and the settlement system 1 according to the embodiment, checkout can be smoothly executed according to the request of the user related to the use of the benefit in the two-dimensional code settlement.

Further, the settlement system 1 can use the two-dimensional code necessary for settlement as a method for allowing the POS terminal 20 to recognize the necessity information of the user. In other words, in the settlement system 1, the two-dimensional code includes the one-time code used for settlement, the user ID, and the necessity information. Therefore, it is not necessary to transmit the necessity information to the POS terminal 20 separately from the information necessary for settlement. Accordingly, the POS terminal 20 can easily execute the process of the server 30 or the like.

In addition, in the settlement system 1 according to the embodiment, the POS terminal 20 causes the display unit 24 to the display benefit content for the user who needs the necessity check. Therefore, the operator can be inhibited from forgetting to execute the necessity check to the user and can notify the content of the usable benefit to the user during the necessity check. Accordingly, the settlement system 1 can improve the service for the user.

In the settlement system 1 according to the embodiment, one object is to inhibit the loss of the characteristics of two-dimensional code settlement where settlement can be rapidly executed. However, when only smooth checkout according to the request of the customer related to the use of the benefit is taken into consideration, the request for necessity information may be transmitted from the POS terminal 20 to the server 30. That is, the POS terminal 20 may receive the user ID and the necessity information corresponding to the user ID from the server 30. For example, in FIG. 11, in the process of ACT 11, the one-time code may be transmitted without transmitting the necessity information, and the processes indicated by a broken line, that is, the request for necessity information from the POS terminal 20 (ACT 100) and the transmission of the necessity information from the server 30 (ACT 101) may be executed. As a result, the POS terminal 20 can receive the user ID and the necessity information from the server 30 without using the two-dimensional code.

### Second Embodiment

Next, a second embodiment will be described with reference to FIG. 14. The second embodiment is different from the first embodiment in that the server 30 does not store the necessity information and the necessity information stored in the mobile terminal 10 is used for generating the two-dimensional code. The same configurations, processes, and the like as those of the first embodiment are denoted by the same reference numerals and the detailed descriptions thereof will not be repeated.

FIG. 14 is a sequence chart illustrating the flow of processes of the settlement system 1. Different points from those of the sequence chart in FIG. 11 illustrating the first embodiment will be mainly described. During the process that the user registers the necessity information, in the mobile terminal 10, when an input of the necessity information is received (ACT 1), the storage control unit 1006 stores the necessity information in the necessity storage unit 112 (ACT 61). As a result, the necessity information is set corresponding to the user ID and is stored in the mobile terminal 10 instead of the server 30.

In the process during checkout, in the server 30, the issuing unit 3004 issues a one-time code (ACT 9), and the output unit 3006 outputs the one-time code (ACT 62). At this time, the server 30 does not store the necessity information and thus does not output the necessity information. The mobile terminal 10 generates a two-dimensional code based on the one-time code received from the server 30 and the user ID and the necessity information stored in the mobile terminal 10 (ACT 12). The processes after this process are the same as those of the first embodiment.

As described above, the mobile terminal 10 according to the second embodiment functions as an information processing device including the transmission unit 1002 that transmits a user ID used for settlement using a code symbol and a request for code information represented by the code symbol to the server 30; the reception unit 1003 that receives the code information from the server 30; and the display control unit 1005 that cause the display unit 11 to display the code symbol indicating the user ID, the code information received by the reception unit 1003, and necessity information set corresponding to the user ID and indicating whether or not it is necessary to check the use of a benefit that is usable during checkout.

In the mobile terminal 10 and the settlement system 1 according to the second embodiment, as in the first embodiment, during two-dimensional code settlement, checkout can be smoothly executed according to the request of the user related to the use of the benefit. In addition, the server 30 does not need to store the necessity information file storing the necessity information of a large number of user IDs. Therefore, the load on the server 30 can be reduced. In addition, when the user registers and changes the necessity information, the communication between the user and the server 30 is not necessary. Therefore, the necessity information can be easily registered and changed.

In addition, in each of the embodiments, the control programs used in the mobile terminal 10, the POS terminal 20, and the server 30 may be provided after being recorded in a computer-readable recording medium such as CD-ROM. In addition, the control programs that are executed by the mobile terminal 10, the POS terminal 20, and the server 30 according to each of the embodiments may be provided by storing the control programs in a computer connected to a network such as the Internet and downloading the control programs through the network or may be provided or distributed through a network such as the Internet.

While certain embodiments have been described, these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A settlement system comprising:
a mobile terminal;
a settlement terminal; and
a server, wherein:
the mobile terminal is configured to transmit a user ID and a request for code information to the server;
the server is configured to transmit the code information to the mobile terminal in response to receiving the request for the code information;
the mobile terminal is configured to:
store necessity information indicating whether a customer associated with the user ID has chosen to require a necessity check before benefits are applied to transactions; and
display a code symbol indicating the code information, the necessity information, and the user ID;
the settlement terminal is configured to:
read the code symbol during a transaction to obtain the user ID, the code information, and the necessity information;
register commodities for purchase during the transaction;
identify the benefits available to the customer based on the user ID;
display the benefits for approval in response to the necessity information indicating that the necessity check is required;
acquire settlement information based on the commodities registered and one or more of the benefits applied to the transaction; and
transmit the user ID, the code information, and the settlement information to the server; and
the server is configured to execute a settlement process based on the user ID, the code information, and the settlement information.

2. The settlement system of claim 1, wherein, if the necessity information indicates that the necessity check is required, the settlement terminal is configured:
receive a selection of one or more of the benefits displayed; and
apply the one or more of the benefits to the transaction based on the selection.

3. The settlement system of claim 1, wherein, if the necessity information indicates that the necessity check is not required, the settlement terminal is configured to automatically apply the one or more of the benefits that are related to the transaction.

4. The settlement system of claim 1, wherein the server includes:
a processing circuit; and
a communications interface configured to facilitate communication with the mobile terminal and the settlement terminal.

5. The settlement system of claim 1, wherein the mobile terminal includes:
a processing circuit;
a communication interface configured to facilitate communication with the server; and
a display device configured to facilitate displaying the display of the code symbol.

6. The settlement system of claim 1, wherein the settlement terminal includes:
a processing circuit;
a communication interface configured to facilitate communication with the server;
a scanner configured to at least one of read the code symbol from the mobile terminal or scan a commodity code from the commodities; and
a display device configured to facilitate displaying the benefits for approval.

7. The settlement system of claim 1, wherein the mobile terminal is configured to generate the code symbol for use in the transaction based on the code information, the necessity information, and the user ID.

8. The settlement system of claim 1, wherein, if the necessity information associated with the user ID is not stored, the necessity information is automatically set to indicate that the necessity check is required before benefits are applied to transactions involving the user ID.

9. The settlement system of claim 1, wherein the code symbol is a QR code.

10. The settlement system of claim 1, wherein the code symbol is a barcode.
